(19) United States
(12) Patent Application Publication
(10) Pub. No.: US 2010/0156609 A1
(43) Pub. Date: Jun. 24, 2010

(54) PORTABLE TERMINAL WITH RFID TAG AND METHOD FOR PROVIDING LOCAL SERVICE USING RFID TAG THEREOF

(75) Inventors: JIYONG KIM, DAEJEON-CITY (KR); SEUNGMIN PARK, DAEJEON-CITY (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, DAEJEON (KR)

(21) Appl. No.: 12/632,045

(22) Filed: Dec. 7, 2009

(30) Foreign Application Priority Data
Dec. 18, 2008 (KR) 10-2008-0129443

(51) Int. Cl. G05B 19/00; G06F 17/00

(52) U.S. Cl. 340/10.5; 235/375

(57) ABSTRACT

When a portable terminal with an RFID tag reaches a predetermined region where an RFID reader is disposed, the present invention inquires whether or not a service provided in the corresponding region is used of a user and provides the corresponding service depending on the response without opening user information of the portable terminal to the outside. According to the present invention, a local server provides a predetermined service to the corresponding portable terminal through a mobile communication server in which a user's portable terminal is registered, such that the portable terminal can receive a predetermined local service by using an RFID without opening user information.

### RELATED APPLICATIONS

The present application claims priority to Korean Patent Application Serial Number 10-2008-0129443, filed on Dec. 18, 2008, the entirety of which is hereby incorporated by reference.

### BACKGROUND OF THE INVENTION

1. Field of the Invention

The present invention relates to a portable terminal with an RFID tag and a method for providing a local service using an RFID tag thereof, and more particularly, to a portable terminal with an RFID tag and a method for providing a local service using an RFID tag thereof that allows a predetermined service to be used by switching a mode of a user terminal to suit a predetermined region or a characteristic of a region or downloading and executing a program.

2. Description of the Related Art

In a general RFID system of a portable terminal, when a portable terminal with an RFID tag enters a predetermined region where an RFID reader is disposed, an RFID in the corresponding region identifies the RFID tag of the portable terminal to provide a predetermined service to the corresponding portable terminal.

At this time, the portable terminal should register portable terminal information in a corresponding server in advance in order to receive a local service using the RFID tag. In this case, when the corresponding portable terminal reaches the predetermined region, the RFID reader disposed in the corresponding region receives RFID tag information of the portable terminal and transmits the RFID tag information to the server. Therefore, the server provides the predetermined service to the corresponding portable terminal on the basis of the registered portable terminal information. At this time, the server automatically provides a service of the corresponding region to a registered portable terminal.

However, in the case when the predetermined local service is provided by this method, user information may be easily exposed through the RFID tag information and since the predetermined local service is collectively provided to portable terminals that reach the predetermined region, users may receive the local service when the users do not want to receive the service.

Further, in order to use the corresponding service, the users should register user information by accessing the server in advance.

### SUMMARY OF THE INVENTION

An object of the present invention is to provide a portable terminal with an RFID tag and a method for providing a local service using an RFID tag thereof that allows the portable terminal to receive a service of a predetermined region by using an RFID without opening user information.

Another object of the present invention is to provide a portable terminal with an RFID tag and a method for providing a local service using an RFID tag thereof that allows a service of a predetermined region to be received by reflecting user's service use intention.

In order to achieve the above-mentioned object, a method for providing a local service using an RFID tag of a portable terminal according to an embodiment of the present invention includes when the corresponding portable terminal reaches a predetermined region, transmitting RFID tag information including information of a mobile communication server in which the corresponding portable terminal is registered to a local server of a corresponding region; receiving a mode switching request message from the mobile communication server in which the corresponding portable terminal is registered at the request of the local server that receives the RFID tag information of the corresponding portable terminal through a mobile communication network; inquiring whether or not a mode is switched of the corresponding user from the mode switching request message in the receiving step; and switching an operation mode of the portable terminal by the mode switching request message when a mode switching request of the corresponding portable terminal is accepted from the inquiry result of inquiring step.

The mode switching request message includes inquiry data to inquire whether or not the mode of the corresponding portable terminal is switched and a control command to switch the operation mode of the corresponding portable terminal with respect to a response of the portable terminal to the inquiry data.

The RFID tag information further includes at least one of an ID of the RFID tag and a user's own ID registered in the corresponding mobile communication server.

In switching the operation mode, the operation mode of the portable terminal is switched to a vibration mode or a silent mode. Meanwhile, in switching the operation mode, a power supply of the corresponding portable terminal is turned off.

Meanwhile, In order to achieve the above-mentioned object, a method for providing a local service using an RFID tag of a portable terminal according to an embodiment of the present invention includes when the corresponding portable terminal reaches a predetermined region, transmitting RFID tag information including information of a mobile communication server in which the corresponding portable terminal is registered to a local server of a corresponding region; receiving a service use inquiry message from the mobile communication server in which the corresponding portable terminal is registered at the request of the local server that receives the RFID tag information of the corresponding portable terminal through a mobile communication network; inquiring whether or not a service is used of the corresponding user from the service use inquiry message in the receiving step and requesting the service of the corresponding local server by using a service number corresponding to the RFID tag when the usage of the corresponding service is accepted; and receiving the local service from the corresponding local server on the basis of the service number corresponding to the RFID tag.

The service use inquiry message includes at least one of inquiry data to inquire whether or not the corresponding local service is used, local service guide information which is usable in the corresponding portable terminal, and information on the local server which provides the corresponding service. Further, the service use inquiry message further includes authentication information of the RFID tag. At this time, the authentication information of the RFID tag is an instance number generated by the local server in correspondence with the RFID tag of the portable terminal.

The local service is a program download service for providing at least one content in the corresponding region.

Meanwhile, in order to achieve the above-mentioned object, a portable terminal with an RFID tag includes an RFID tag that, when the corresponding portable terminal reaches a predetermined region, transmits RFID tag information including information of a mobile communication server in which the corresponding portable terminal is registered to a local server of a corresponding region; and a data processing unit that executes the corresponding local service when the user accepts usage of the local service in accordance with a user's control command at the time of receiving an inquiry message to verify whether or not a user uses the local service from the mobile communication server at the request of the local server that receives the RFID tag information. Herein, the inquiry message includes at least one of a mode switching request message or a service use inquiry message.

The mode switching request message includes inquiry data to inquire whether or not a mode of the corresponding portable terminal is switched and a control command to switch an operation mode of the corresponding portable terminal in correspondence with a response of the portable terminal to the inquiry data.

The RFID tag information further includes at least one of an ID of the RFID tag and a user's own ID registered in the corresponding mobile communication server.

Meanwhile, in the case in which the inquiry message is the mode switching request message, the data processing unit switches the operation mode of the corresponding portable terminal by the mode switching request message when the user accepts switching the operation mode. At this time, the data processing unit switches the operation mode of the corresponding portable terminal to a vibration mode or a silent mode when the operation mode of the portable terminal is switched. Meanwhile, the data processing unit turns off a power supply of the corresponding portable terminal when the operation mode of the portable terminal is switched.

Meanwhile, the service use inquiry message includes at least one of inquiry data to inquire whether or not the corresponding local service is used, guide information of the local service which is usable in the corresponding portable terminal, and information on the local server which provides the corresponding service. Further, the service use inquiry message further includes authentication information of the RFID tag. At this time, the authentication information of the RFID tag is an instance number generated by the local server in correspondence with the RFID tag of the portable terminal.

Further, the data processing unit receives the service from the corresponding local server on the basis of the authentication information of the RFID tag when the corresponding local service is used from the service use inquiry message.

According to the present invention, a ubiquitous service can be provided in each region through a user's portable terminal and users can safely receive the corresponding service from a local server even though the users do not register users' own portable terminal information here and there.

Further, according to the present invention, it is advantageous that the portable terminal receives a service of a predetermined region by using an RFID without opening user information and when the service of the corresponding region is provided, the service of the predetermined region is provided by reflecting a user's service use intention. As a result, the users need not to use a collectively transmitted service when the users do not want the service.

### BRIEF DESCRIPTION OF THE DRAWINGS

FIG. 1 is an exemplary diagram illustrating a system configuration for implementing a method for providing a local service using an RFID tag of a portable terminal according to an embodiment of the present invention;

FIGS. 2A to 2C are block diagrams illustrating a system configuration of FIG. 1;

FIGS. 3 to 4D are exemplary diagrams for illustrating an operation of a portable terminal according to an embodiment of the present invention; and

FIGS. 5 and 6 are flowcharts illustrating an operational flow with respect to a method for providing a local service using an RFID tag of a portable terminal according to an embodiment of the present invention.

### DETAILED DESCRIPTION OF THE PREFERRED EMBODIMENTS

Hereinafter, embodiments of the present invention will be described with reference to the accompanying drawings.

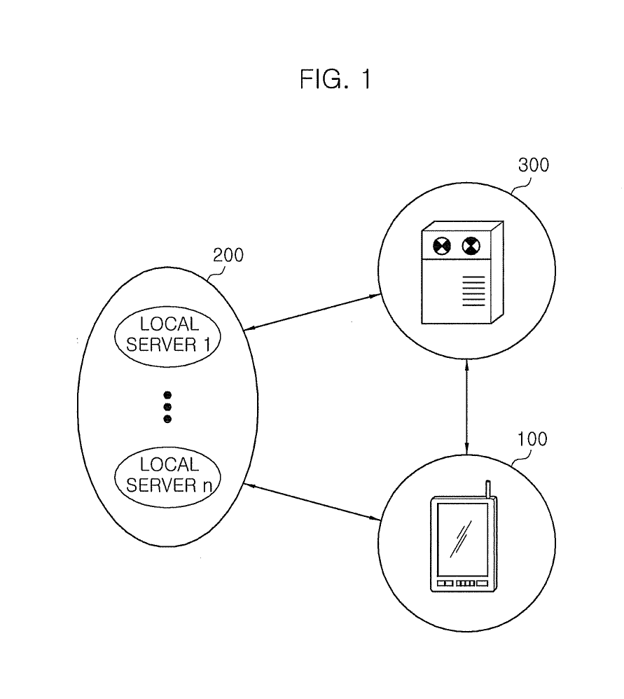

FIG. 1 is a diagram illustrating a system configuration for implementing a method for providing a local service using an RFID tag of a portable terminal according to an embodiment of the present invention.

Referring to FIG. 1, a local server 200 for providing a local service of a predetermined region is present in the corresponding region. Further, a portable terminal 100 that receives the local service from the corresponding local server 200 is present. Herein, the local service corresponds to a mode switching notification service to a user's portable terminal in the corresponding region and further corresponds to a program download service that provides a guide map of the corresponding region, instructions, an interpretation service, etc.

At this time, the portable terminal 100 is provided with a communication device that can communicate with each local server 200 and the communication device corresponds to the RFID tag. Therefore, when the portable terminal 100 reaches a region where an RFID reader is disposed, the portable terminal 100 transmits an RFID signal to the local server 200 of the corresponding region and the corresponding local server 200 identifies the corresponding portable terminal 100 on the basis of the transmitted RFID signal from the corresponding portable terminal 100. Herein, the portable terminal 100 transmits only information such as ID of the RFID tag, ID of a mobile communication server and a user's own ID to the RFID reader.

Further, a mobile communication server 300 is present, which transmits messages between the local server 200 and the portable terminal 100. In other words, when the local server 200 identifies the portable terminal 100 that reaches the corresponding region, the local server 200 transmits a message for verifying whether or not the service is used to the mobile communication server 300. At this time, the mobile communication server 300 transmits the message received from the local server 200 to the corresponding portable terminal 100.

The portable terminal 100 inquires of the user whether or not to use the local service of the corresponding region at the time of receiving the message from the mobile communication server 300. Herein, the portable terminal 100 transmits a user's response result to the corresponding local server when the user wants to use the local service.

Therefore, the portable terminal 100 can receive the local service of the corresponding region without opening personal information to the local server 200. The local server 200 can also provide the local service through the mobile communication server 300 even though the local server 200 does not know information of the portable terminal 100.

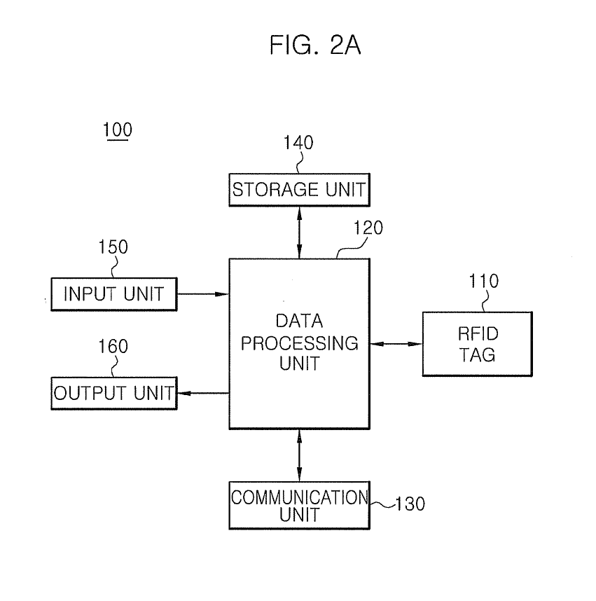

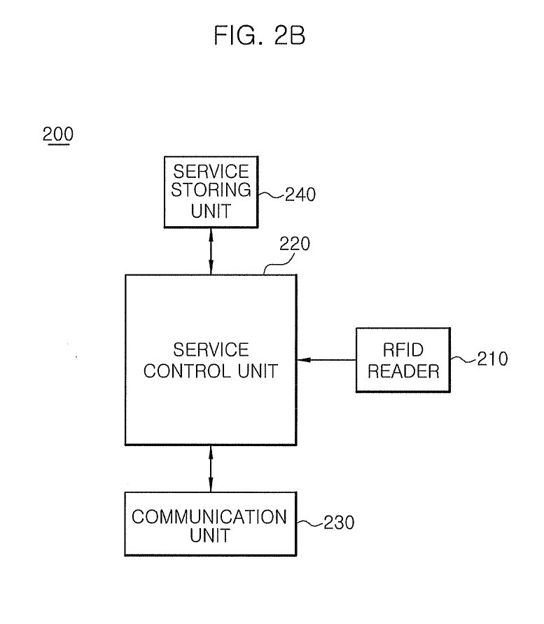

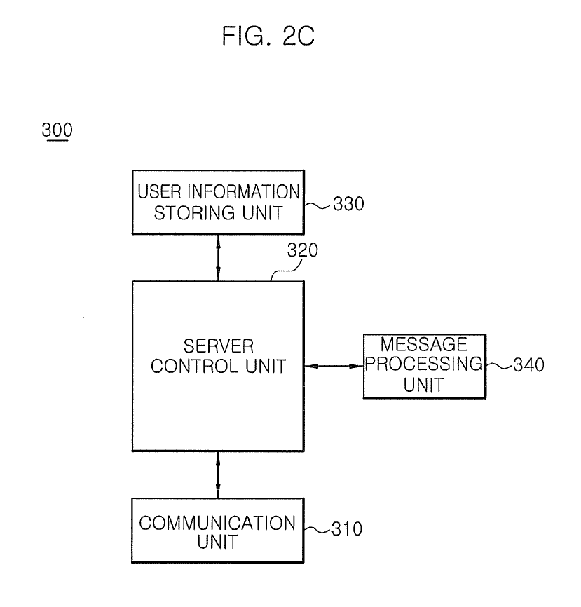

Hereinafter, referring to FIGS. 2A to 2C, the system configuration of FIG. 1 will be described in more detail. FIGS. 2A to 2C are block diagrams illustrating the system configuration of FIG. 1.

First, FIG. 2A is a block diagram illustrating a configuration of a portable terminal according to an embodiment of the present invention. Referring to FIG. 2A, the portable terminal according to the embodiment of the present invention includes an RFID tag 110, a data processing unit 120, a communication unit 130, a storage unit 140, an input unit 150, and an output unit 160.

The RIFD tag 110 transmits and receives predetermined data by communicating with the RIFD reader by using a radio frequency identification technology. The RFID tag 110 modulates a phase or an amplitude and transmits data stored in the tag to the RFID reader when receiving an RF signal from the RFID reader of the local server 200. At this time, the RFID tag 110 transmits ID of the RFID tag, user's own ID, and information (i.e., information of a subscribed communication service company) of the mobile communication server 300 in which the corresponding portable terminal 100 is registered to the RFID reader.

Set data for operating the portable terminal 100 and information on the RFID tag 110 are stored in the storage unit 140. The data processing unit 120, as a means for controlling an entire operation of the portable terminal 100, controls operations of the RFID tag 110, the communication unit 130, the storage unit 140, the input unit 150, and the output unit 160. The input unit 150 serves as a means for receiving a control command from the user. When a user's control command is inputted through the input unit 150, the data processing unit 120 performs the corresponding operation in accordance with the inputted control command. Meanwhile, the output unit 160, as a means for outputting the operation of the portable terminal 100, outputs a processing operation by the data processing unit 120. Further, when the local service is received from the local server 200, the output unit 160 displays an output screen of the corresponding local service. At this time, the output unit 160 includes a display device such as a monitor and may have a touch screen. In this case, the input unit 150 may not separately be installed.

FIG. 2B is a block diagram of a configuration of a local server according to an embodiment of the present invention. Referring to FIG. 2B, the local server 200 includes an RFID reader 210, a service control unit 220, a communication unit 230, and a service storing unit 240. The RFID reader 210 periodically transmits a radio signal. At this time, the radio signal transmitted from the RFID reader 210 is transmitted only within a predetermined range. If the RFID tag 110 of the portable terminal 100 is positioned within the predetermined range, the corresponding portable terminal 100 receives the signal transmitted from the RFID reader 210.

Meanwhile, the RFID reader 210 receives information of the RFID tag 110 from the RIFD tag 110 that is positioned within the predetermined range. At this time, the received information of the RFID tag 110 includes RFID, user's own ID, and information of the mobile communication server 300 in which the corresponding portable terminal 100 is registered.

The communication unit 230 is provided with a module that supports a radio communication type communication interface. Further, the communication unit 230 transmits and receives predetermined data with the mobile communication server 300. The service storing unit 240 stores local service information of the corresponding region. At this time, the local service information includes mode switching information of the portable terminal 100, a predetermined program, etc.

The service control unit 220 controls the operation of the RFID reader 210. When the information of the RFID tag 110 positioned within the predetermined range is received from the RFID reader 210, the service control unit 220 detects the information of the mobile communication server 300 to which the corresponding portable terminal 100 subscribes from the received information of the RFID tag 110.

The service control unit 220 generates a service use inquiry message on the basis of the information stored in the service storing unit 240. The service control unit 220 transmits the service use inquiry message generated to verify whether or not the portable terminal 100 uses the service to the mobile communication server 300. Herein, the service use inquiry message is a mode switching request of the portable terminal 100 or a program download guidance message.

At this time, the service use inquiry message includes the RFID received from the RFID tag 110 and the user's own ID information. Further, the service use inquiry message further includes information of the local server 200 such as ID, an address, etc. of the corresponding local server 200 and information of a service which can be provided to the corresponding local server 200.

FIG. 2C is a block diagram illustrating a configuration of a mobile communication server according to an embodiment of the present invention. Referring to FIG. 2C, the mobile communication server 300 includes a message processing unit 340, a server control unit 320, a user information storing unit 330, and a communication unit 310. The user information storing unit 330 stores information of the portable terminal 100 registered in the corresponding mobile communication server 300 and user information of the corresponding portable terminal 100, i.e., subscriber information. The communication unit 310 is provided with the module that supports the radio communication type communication interface. The communication unit 310 transmits and receives data to and from the local server 200 and transmits and receives predetermined data with the portable terminal 100. At this time, the communication unit 310 transmits and receives the predetermined data between the mobile communication server 300 and the portable terminal 100. That is, when the service use inquiry message is received from the local server 200, the communication unit 310 transmits the service use inquiry message received from the local server 200 to the portable terminal 100.

When the service use inquiry service is received from the local server 200 through the communication unit 310, the message processing unit 340 reads information included in the corresponding message and detects user information including RFID of the corresponding portable terminal 100, user's own ID, etc. Further, the message processing unit 340 detects information of the local server 200 such as ID, an address, etc. of the local server 200 and service information that which can be provided by the corresponding local server 200 from the received message.

The server control unit 320 detects information of the corresponding user, which is stored in the user information storing unit 330 on the basis of message information detected by the message processing unit 340. At this time, the server control unit 320 detects the number of a portable terminal 100 of a user corresponding to user's own ID. Meanwhile, the server control unit 320 transmits the service use inquiry message received from the local server 200 to the detected number of the portable terminal 100.

When the service use inquiry message is received from the mobile communication server 300, the data processing unit 120 of the portable terminal 100 outputs the received service use inquiry message through the output unit 160. At this time, when a predetermined control command is inputted by the user, a response message to allow or interrupt the corresponding service use inquiry message is transmitted to the mobile communication server 300 in accordance with the inputted control command. At this time, the mobile communication server 300 transmits the response message received from the portable terminal 100 to the local server. At this time, the portable terminal 100 may transmit the response message directly to the local server 200 without transmitting the response message to the mobile communication server 300.

If the response message to interrupt use of the corresponding service is received from the portable terminal 100 in accordance with the control command inputted by the user, the local server 200 does not provide the corresponding local service to the corresponding portable terminal 100 any longer. Meanwhile, if the response message to allow the use of the corresponding service is received from the portable terminal 100 in accordance with the control command inputted by the user, the local server 200 provides the corresponding local service at the time of receiving a request from the corresponding portable terminal 100.

If the service use inquiry message received from the mobile communication server 300 is a mode switching request message, the data processing unit 120 of the portable terminal 100 outputs inquiry data to switch an operation mode. At this time, when a control command to allow a mode switching request is inputted by the user, the data processing unit 120 of the portable terminal 100 switches the operation mode of the portable terminal 100 to a vibration mode or a silent mode. Meanwhile, the data processing unit 120 may allow a power supply of the portable terminal 100 to be turned off.

Herein, the mode switching request message includes inquiry data to request switching of the operation mode of the corresponding portable terminal 100 and a control command to switch the operation mode of the corresponding portable terminal 100 with respect to a response of the portable terminal 100 to the corresponding inquiry data. Therefore, the operation mode of the data processing unit 120 of the portable terminal 100 is switched by the control command included in the mode switching request message.

Meanwhile, when a command to allow use of the corresponding service is received by the user, the data processing unit 120 detects service information usable in the corresponding portable terminal 100 from the received message. Further, the data processing unit 120 detects information of the corresponding local server 200.

Accordingly, when the data processing unit 120 wants to use the corresponding service, the data processing unit 120 extracts information of the service among service information which can be provided from the corresponding local server 200 and requests the corresponding service of the corresponding local server 200. At this time, the data processing unit 120 requests the service of the corresponding local server 200 by using authentication information with the RFID tag of the corresponding portable terminal 100. Herein, the authentication information with respect to the RFID tag is an instance number generated by the RFID reader of the local server 200.

The corresponding local server 200 extracts the corresponding service stored in the service storing unit 240 and transmits the corresponding service to the portable terminal 100 at the request of the portable terminal 100. At this time, the corresponding local server 200 transmits a corresponding program by using the instance number of the portable terminal 100.

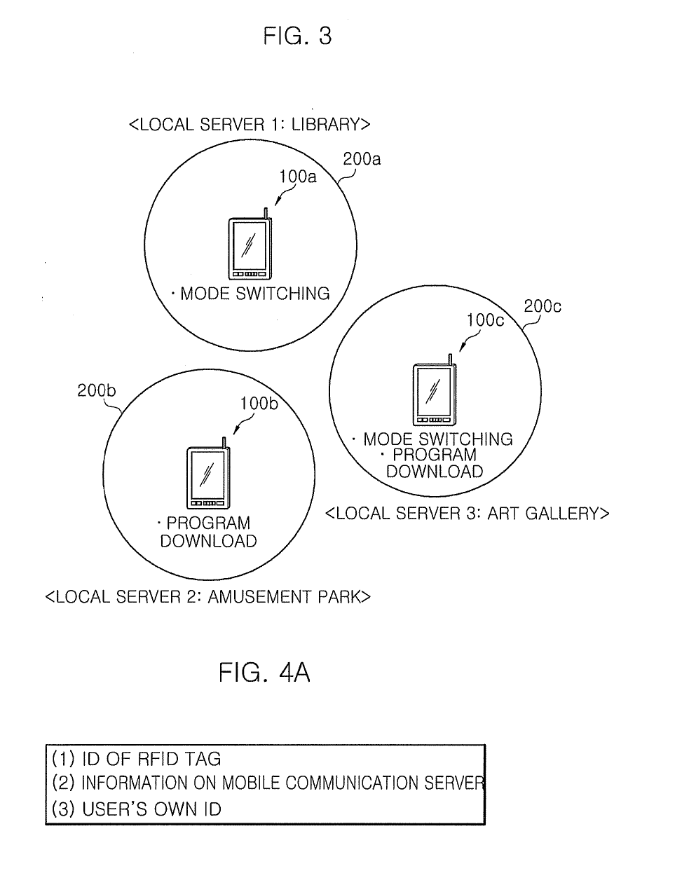

FIG. 3 is an exemplary diagram illustrating an operation with respect to a method for providing a local service using an RFID tag of a portable terminal according to an embodiment of the present invention.

Referring to FIG. 3, the local server 200 may be a server that is positioned in a predetermined region such as a park, an amusement park, etc. and a server in a predetermined space such as a library, an art gallery, etc. or in a building. In FIG. 3, a local server 1 200a is the local server 200 in the library and a local server 2 200b is the local server 200 of the amusement park. Further, a local server 3 200c is the local server 200 of the art gallery.

When the portable terminal 100 is positioned in the library building which is the local server 1 200a, the RFID tag 110 of the portable terminal 100 transmits information of the RFID tag 110 to the local server 1 200a in response to the radio signal transmitted from the RFID reader 210 of the local server 1 200a. At this time, the local server 1 200a detects RFID received from the portable terminal 100, user's own ID, and information of the mobile communication server 300 which the corresponding portable terminal 100 is registered.

The local server 1 200a generates a message to request switching the operation mode of the portable terminal 100 to the vibration mode or the silent mode. Further, the local server 1 200a transmits the generated message to the mobile communication server 300 in which the corresponding portable terminal 100 is registered. At this time, the local server 1 200a transmits the RFID and the user's own ID together with the message. Further, the local server 1 200a transmits information of the corresponding local server 1 200a altogether at the time of transmitting the message. In this case, since the local server 1 200a requests switching the operation mode of the corresponding portable terminal 100, the message needs not to include an additional instance number for transmitting data to the portable terminal 100.

At this time, the mobile communication server 300 that receives the mode switching request message from the local server 1 200a detects the information of the corresponding portable terminal 100 from the RFID and the user's own ID and transmits the mode switching request message transmitted from the local server 1 200a to the corresponding portable terminal 100 on the basis of the detected information of the portable terminal 100. That is, the portable terminal 100 receives the mode switching request message transmitted by the local server 1 200a through the mobile communication server 300 in which the corresponding portable terminal 100 is registered. Therefore, even though the local server 1 200a does not know detailed information such as a portable terminal number, etc., security of personal information is increased by transmitting the corresponding message through the mobile communication server 300 in which the corresponding portable terminal 100 is registered. Further, the portable terminal 100 also has an advantage of receiving the local service of the corresponding region without opening the personal information to the local server 200.

The portable terminal 100 outputs the mode switching request message received from the mobile communication server 300. The portable terminal 100 generates and transmits the corresponding response message to the mobile communication server 300 in accordance with the control command inputted by the user. Of course, the mobile communication server 300 transmits the response message received from the portable terminal 100 to the local server 1 200a again.

If a control command to allow mode switching is inputted by the user, the corresponding portable terminal 100 performs a mode switching operation in accordance with the control command inputted by the user. At this time, the portable terminal 100 allows the operation mode of the corresponding portable terminal 100 to be switched to the vibration mode or the silent mode or the power supply of the portable terminal 100 to be turned off. The portable terminal 100 generates and transmits an allowance response message corresponding to the control command inputted by the user to the mobile communication server 300. At this time, the mobile communication server 300 transmits the allowance response message received from the portable terminal 100 to the local server 1 200a.

Meanwhile, when a control command to reject the mode switching is inputted by the user, the corresponding portable terminal 100 generates and transmits a rejection response message corresponding to the corresponding control command to the mobile communication server 300. At this time, the mobile communication server 300 transmits the response message received from the portable terminal 100 to the local server 1 200a. In this case, the local server 1 200a may transmit a warning message, etc. to the corresponding portable terminal 100 through the mobile communication server 300.

When the portable terminal 100 is positioned in the amusement park which is the local server 2 200b, the RFID tag 110 of the portable terminal 100 transmits the information of the RFID tag 110 to the local server 2 200b in response to the radio signal transmitted from the RFID reader 210 of the local server 2 200b. At this time, the local server 2 200b detects the ID of the RFID tag received from the portable terminal 100, the user's own ID, and the information of the mobile communication server 300 which the corresponding portable terminal 100 is registered.

The local server 2 200b generates a message for verifying whether or not a service of a program for guiding the amusement park is used. The local server 2 200b transmits the generated message to the mobile communication server 300 in which the corresponding portable terminal 100 is registered. At this time, the service use inquiry message includes at least one of the ID of the RFID tag, the user's own ID, the information of the local server 2 200b, the service information, and the instance number generated with respect to the RFID tag 110 of the corresponding portable terminal 100. Thereafter, the instance number included in the service use inquiry message is used to transmit the program between the local server 2 200b and the portable terminal 100.

At this time, the mobile communication server 300 that receives the mode switching request message from the local server 2 200b detects the information of the corresponding portable terminal 100 from the RFID and the user's own ID and transmits the service use inquiry message transmitted from the local server 2 200b to the corresponding portable terminal 100 on the basis of the detected information of the portable terminal 100. That is, the portable terminal 100 receives the service use inquiry message transmitted by the local server 2 200b through the mobile communication server 300 in which the corresponding portable terminal 100 is registered.

Therefore, even though the local server 2 200b does not know the detailed information such as the number of the portable terminal 100, etc., the security of the personal information is increased by transmitting the corresponding message through the mobile communication server 300 in which the corresponding portable terminal 100 is registered. Further, the portable terminal 100 also has the advantage of receiving the local service of the corresponding region without opening the personal information to the local server 200.

The portable terminal 100 outputs the service use inquiry message received from the mobile communication server 300. The portable terminal 100 generates and transmits the corresponding response message to the mobile communication server 300 in accordance with the control command inputted by the user. Of course, the mobile communication server 300 transmits the response message received from the portable terminal 100 to the local server 2 200b again.

Meanwhile, when the control command to allow use of the service is inputted by the user, the portable terminal 100 generates and transmits the allowance response message corresponding to the control command inputted by the user to the mobile communication server 300. At this time, the mobile communication server 300 transmits the allowance response message received from the portable terminal 100 to the local server 2 200b.

Further, the portable terminal 100 verifies the information of the local server 200 and the service information (program information, etc.) that are included in the service use inquiry message in accordance with the control command inputted by the user. Therefore, the corresponding portable terminal 100 requests the program stored in the corresponding local server 200 of the local server 2 200b by using the verified information of the local server 200. At this time, the portable terminal 100 transmits the instance number with respect to the RFID tag 110 of the corresponding portable terminal 100 altogether at the time of requesting download of a program of the local server 2 200b.

The local server 2 200b detects and transmits the program stored in the service storing unit 240 to the corresponding portable terminal 100 in accordance with the request of the portable terminal 100. At this time, the local server 2 200b transmits the program to the corresponding portable terminal 100 by using the instance number with respect to the RFID tag 110 of the corresponding portable terminal 100. The portable terminal 100 executes the program provided from the local server 2 200b to receive the guidance of the amusement park.

Meanwhile, when the control command to reject the mode switching is inputted by the user, the corresponding portable terminal 100 generates and transmits the rejection response message corresponding to the corresponding control command to the mobile communication server 300. At this time, the mobile communication server 300 transmits the response message received from the portable terminal 100 to the local server 2 200b.

When the portable terminal 100 is positioned in the art gallery which is the local server 3 200c, the RFID tag 110 of the portable terminal 100 transmits the information of the RFID tag 110 to the local server 3 200c in response to the radio signal transmitted from the RFID reader 210 of the local server 3 200b. At this time, the local server 3 200c detects the RFID received from the portable terminal 100, the user's own ID, and the information of the mobile communication server 300 in which the corresponding portable terminal 100 is registered.

The local server 3 200c generates the message to request switching the operation mode of the portable terminal 100 to the vibration mode or the silent mode. The local server 3 200c generates a message for verifying whether or not a service of a program for guiding the art gallery is used. The local server 3 200c transmits the generated message to the mobile communication server 300 in which the corresponding portable terminal 100 is registered. At this time, the local server 3 200c may transmit the service use inquiry message including the mode switching request message and may separately transmit the service use inquiry message and the mode switching request message to the mobile communication server 300.

Herein, the service use inquiry message includes at least one of the ID of the RFID tag, the user's own ID, the information of the local server 3 200c, the service information of the corresponding region, and the instance number generated with respect to the RFID tag 110 of the corresponding portable terminal 100. Thereafter, the instance number included in the service use inquiry message is used to transmit a guide program or the art gallery between the local server 3 200c and the portable terminal 100.

At this time, the mobile communication server 300 that receives the service use inquiry message from the local server 3 200c detects the information of the corresponding portable terminal 100 from the RFID and the user's own ID and transmits the service use inquiry message transmitted from the local server 3 200c to the corresponding portable terminal 100 on the basis of the detected information of the portable terminal 100. That is, the portable terminal 100 receives the service use inquiry message transmitted by the local server 3 200c through the mobile communication server 300 in which the corresponding portable terminal 100 is registered. If the mode switching request message is separately transmitted, the portable terminal 100 also receives the mode switching request message from the mobile communication server 300.

Therefore, even though the local server 2 200b does not know the detailed information such as the number of the portable terminal 100, etc., the security of the personal information is increased by transmitting the corresponding message through the mobile communication server 300 in which the corresponding portable terminal 100 is registered. Further, the portable terminal 100 also has the advantage of receiving the local service of the corresponding region without opening the personal information to the local server 200.

First, the portable terminal 100 outputs the mode switching request message and the service use inquiry message received from the mobile communication server 300. The portable terminal 100 generates and transmits the corresponding response message to the mobile communication server 300 in accordance with the control command inputted by the user. Of course, the mobile communication server 300 transmits the response message received from the portable terminal 100 to the local server 3 200c again.

First, when the control command to allow the mode switching is inputted by the user, the portable terminal 100 switches the operation of the corresponding portable terminal 100 to the vibration mode or the silent mode or turns off the power supply in accordance with the control command inputted by the user.

Further, when the control command to allow the use of the service is inputted by the user, the portable terminal 100 verifies the information of the local server 200 and the service information (program information, etc.) that are included in the service use inquiry message in accordance with the control command inputted by the user. Therefore, the corresponding portable terminal 100 requests the program stored in the corresponding local server 200 of the local server 3 200c by using the verified information of the local server 200. At this time, the portable terminal 100 transmits the instance number with respect to the RFID tag 110 of the corresponding portable terminal 100 altogether at the time of requesting program downloading of the local server 3 200c.

The local server 3 200c detects and transmits the program stored in the service storing unit 240 to the corresponding portable terminal 100 in accordance with the request of the portable terminal 100. At this time, the local server 3 200c transmits the program to the corresponding portable terminal 100 by using the instance number with respect to the RFID tag 110 of the corresponding portable terminal 100. The portable terminal 100 executes the program provided from the local server 3 200c to receive the guidance of the art gallery.

Meanwhile, when the control command to reject the mode switching or the use of the service is inputted by the user, the corresponding portable terminal 100 generates and transmits the rejection response message corresponding to the corresponding control command to the mobile communication server 300. At this time, the mobile communication server 300 transmits the response message received from the portable terminal 100 to the local server 3200c.

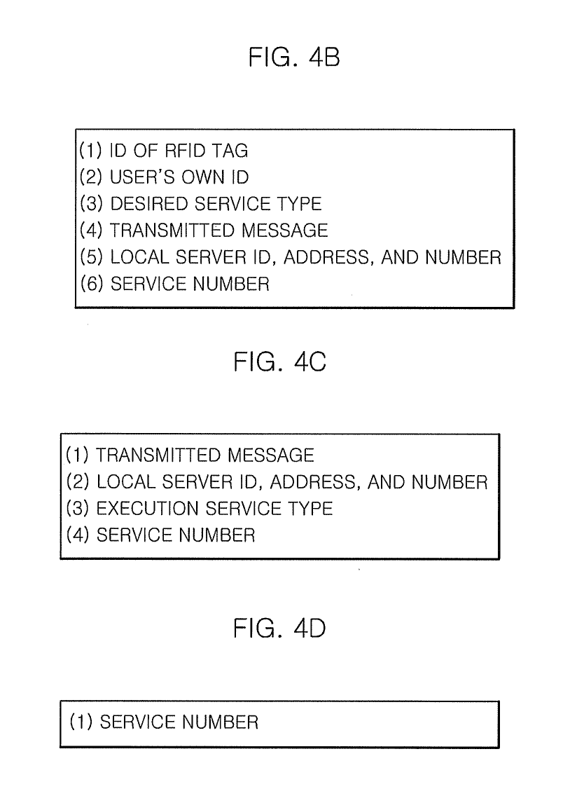

FIGS. 4A to 4D illustrate information included in a message that is transmitted and received while a method for providing a local service using an RFID tag of a portable terminal according to an embodiment of the present invention is implemented.

First, FIG. 4A illustrates a message transmitted from the RFID tag 110 of the portable terminal 100 to the RFID reader 210. The message of FIG. 4A includes (1) ID of the RFID tag. The message of FIG. 4A further includes (2) information of the mobile communication server 300 for the local server 200 to grasp the information of the mobile communication server 300 in which the portable terminal 100 is registered. Lastly, the message of FIG. 4A includes (3) user's own ID information used to detect the information of the corresponding portable terminal 100 when the local server 200 requests transmission of the message to the portable terminal 100 of the mobile communication server 300.

FIG. 4B illustrates a message transmitted to the mobile communication server 300, as the service use inquiry message of the portable terminal 100 that receives the information of the RFID tag 110. The message of FIG. 4B includes (1) the ID of the RFID tag and (2) the user's own ID information that are included in the message of FIG. 4A. (1) The ID of the RFID tag and (2) the user's own ID information are used for the mobile communication server 300 to detect the information of the corresponding user's portable terminal. The message of FIG. 4B further includes (3) a service type which the local server 200 intends to provide and (4) an inquiry message to message a user's intention. For example, the message of FIG. 4B includes the service information on a service for requesting the mode switching or a service for guiding the program.

The message of FIG. 4B includes (5) local server information such as ID, an address, a number, etc. of the local server and includes (6) the service information. Herein, (6) the service information, as an instance number generated by the local server 200 at the time of detecting an RFID tag signal through the RFID reader 210, is used to transmit the data from the local server 200 to the portable terminal 100. Herein, the instance number is a one-time number that varies each time in spite of the same service or the same user.

FIG. 4C illustrates a message which the mobile communication server 300 that receives the service use inquiry message from the local server 200 transmits to the portable terminal 100. The message of FIG. 4C does not include the ID of the RFID tag and the user's own ID information that are included in the message of FIG. 4B.

Meanwhile, the message of FIG. 4C includes (3) the service type, (4) the inquiry message for inquiring the user's intention, and (5) the service number that are included in the message of FIG. 4B. For example, the message of FIG. 4B includes the service information on the service for requesting the mode switching or the service for guiding the program.

The message of FIG. 4B includes (5) the local server information such as the ID, the address, the number, etc. of the local server 200 and includes (6) the service information. Herein, (6) the service information is an instance number generated by the local server 200, which corresponds to the RFID tag 110 of the portable terminal 100.

Therefore, the RFID reader 210 of the local server 200 receives the ID of the RFID tag, the user's own ID, and the information of the mobile communication server 300 in which the corresponding portable terminal 100 is registered and transmits a predetermined message to the corresponding mobile communication server 300.

The above-configured operation of the present invention will now be described.

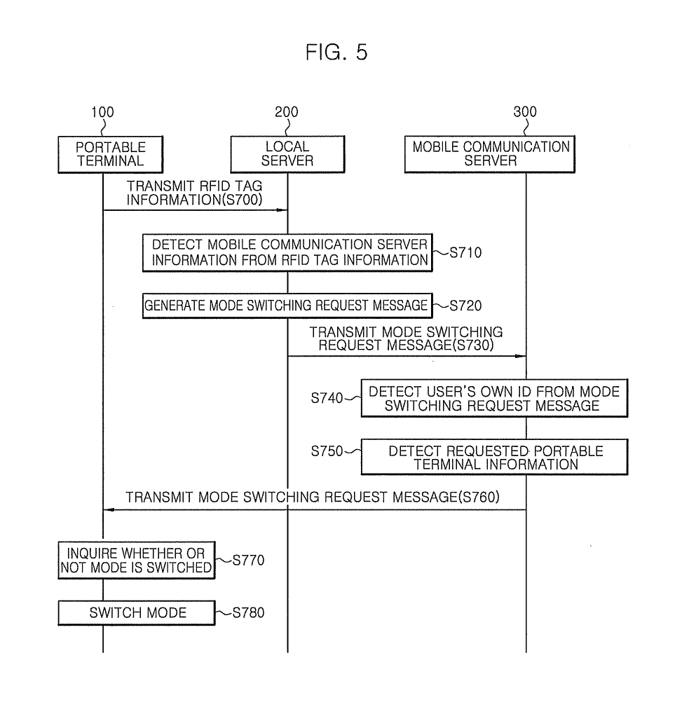

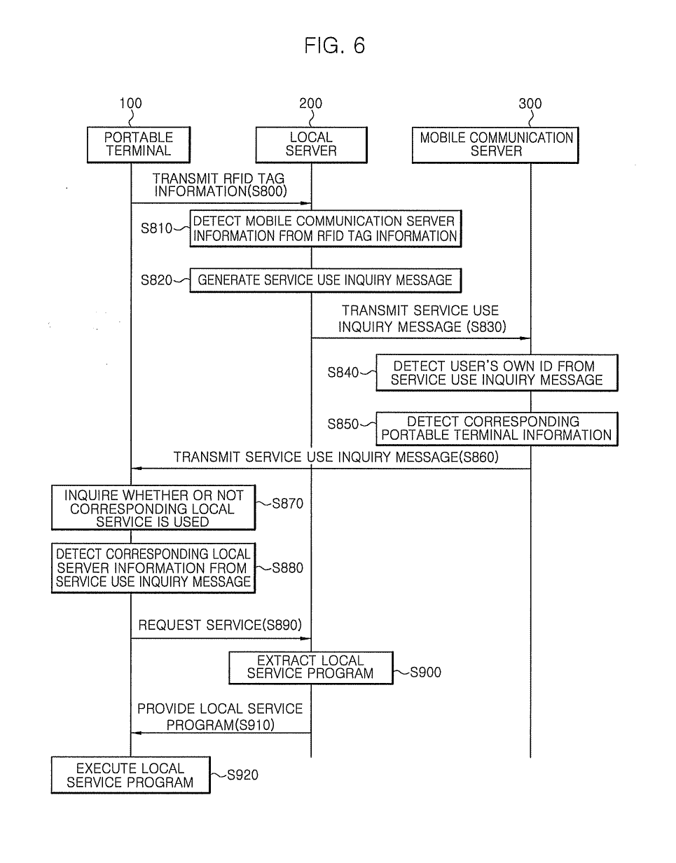

FIGS. 5 and 6 are flowcharts illustrating an operational flow with respect to a method for providing a local service using an RFID tag of a portable terminal according to an embodiment of the present invention.

First, FIG. 5 illustrates an embodiment when a service use inquiry message is a mode switching request message and illustrates a process in which a mode switching operation of a portable terminal that reaches a predetermined region is made.

Referring to FIG. 5, when a portable terminal 100 reaches a region where an RFID reader is installed, an RFID tag 110 of the portable terminal 100 transmits registered RFID tag information to an RFID reader 210 (S700). At this time, the transmitted RFID tag information includes at least one of radio identification information (ID) of the RFID tag 110, the information of a mobile communication server 300 in which the corresponding portable terminal 100 is registered, and user's own ID registered in the corresponding mobile communication server 300.

A local server 200 that receives the RFID tag information of the portable terminal 100 from the RFID reader detects the information of the mobile communication server 300 in which the corresponding portable terminal 100 is registered among the received RFID tag information (S710).

Further, the local server 200 generates a message for inquiring the corresponding portable terminal 100 to use a local service of the corresponding region. At this time, the generated message is the mode switching request message (S720).

The mode switching request message includes ID of the RFID tag 110 and user's own ID information. Further, the mode switching request message includes service information for verifying that the corresponding message is the mode switching message and includes an inquiry message for inquiring a user to switch a mode and a control command to allow an operation mode of the corresponding portable terminal 100 to be switched with respect to a response of the inquiry message.

The local server 200 requests mode switching of the portable terminal by transmitting the mode switching request message to the mobile communication server 300 detected from the RFID tag information. At this time, the mobile communication server 300 detects the user's own ID from the received mode switching request message (S740). Further, the mobile communication server 300 detects information of the portable terminal 100 corresponding to the user's own ID (S750) and transmits the mode switching request message to the corresponding portable terminal 100 on the basis of the detected portable terminal information (S760). At this time, the mobile communication server 300 performs transmission excluding the ID of the RFID tag 110 and the user's own ID information that are included in the mode switching request message. Further, the mobile communication server 300 may convert the corresponding mode switching request message to suit a type of the corresponding portable terminal 100 and transmit the converted message.

Meanwhile, when the mode switching request message is received through the mobile communication server 300, the portable terminal 100 outputs inquiry data included in the mode switching request message and inquires the user to switch the operation mode of the portable terminal (S770).

If a control command to accept the mode switching is inputted by the user, the portable terminal 100 switches the operation mode on the basis of the control command included in the mode switching request message (S780). At this time, the operation mode of the portable terminal 100 may be switched to a vibration mode or a silent mode and a power supply of the portable terminal 100 may be turned off.

FIG. 6 illustrates an embodiment when the service use inquiry message is the service use inquiry message and illustrates a process in which the local service is provided to the portable terminal 100 that reaches the predetermined region.

Referring to FIG. 6, when the portable terminal 100 reaches the region where the RFID reader is installed, the RFID tag 110 of the portable terminal 100 transmits the registered RFID tag information to the RFID reader 210 (S800). At this time, the transmitted RFID tag information includes at least one of the radio identification information (ID) of the RFID tag 110, the information of the mobile communication server 300 in which the corresponding portable terminal 100 is registered, and the user's own ID registered in the corresponding mobile communication server 300.

The local server 200 that receives the RFID tag information of the portable terminal 100 from the RFID reader 210 detects the information of the mobile communication server in which the corresponding portable terminal 100 is registered among the received RFID tag information (S810).

Further, the local server 200 generates the message for inquiring the corresponding portable terminal 100 to use the local service of the corresponding region. At this time, the generated message is the service use inquiry message (S820).

The service use inquiry message includes the ID of the RFID tag 110 and the user's own ID information. Further, the service use inquiry message includes the service information to verify a message for inquiring whether or not the service is used, such as a program download service, etc. and further includes the inquiry message for inquiring the user to use the corresponding local service.

Moreover, when the portable terminal 100 accepts the use of the local service, the service use inquiry message further includes local server information such as an ID address, a number, etc. of the corresponding local server 200 and a service number of the RFID tag 110 for allowing the local server 200 to identify the corresponding portable terminal 100. Herein, the service number is an instance number generated from the local server 200, which corresponds to the RFID tag 110.

The local server 200 transmits service information that is usable in the corresponding portable terminal 100 by transmitting the service use inquiry message to the mobile communication server 300 detected from the RFID tag information (S830). At this time, the mobile communication server 300 detects the user's own ID included in the mode switching request message received from the local server 200 (S840). Further, the mobile communication server 300 detects the information of the portable terminal 100 corresponding to the user's own ID (S850) and transmits the service use inquiry message to the corresponding portable terminal 100 on the basis of the detected portable terminal information (S860).

At this time, the mobile communication server 300 performs transmission excluding the ID of the RFID tag 110 and the user's own ID information that are included in the service use inquiry message. Further, the mobile communication server 300 may convert the corresponding service use inquiry message to suit the type of the corresponding portable terminal 100 and transmit the converted message.

Meanwhile, when the service use inquiry message is received through the mobile communication server 300, the portable terminal 100 outputs the inquiry data included in the service use inquiry message and inquires the user to switch the user to use the local service (S870).

If a control command to accept using the local service is inputted by the user, the portable terminal 100 detects the information of the local service 200, which is included in the service use inquiry message (S880). Further, the portable terminal 100 requests the local service of the corresponding local server 200 (S890). At this time, the portable terminal 100 transmits the service number of the RFID tag 110, which is included in the service use inquiry message altogether.

The local server 200 extracts the corresponding local service program (S900) at the request of the portable terminal 100 and provides the extracted local service program to the corresponding portable terminal 100 on the basis of the service number of the RFID tag 110, which is transmitted from the portable terminal 100 (S910). Therefore, the portable terminal 100 receives and executes the local service program from the corresponding local server 200 only when the user accepts the use of the local service (S920).

Herein, the processes of FIGS. 5 and 6 may be performed at the same time.

As described above, in a portable terminal with an RFID tag and a method for providing a local service using an RFID tag thereof according to the present invention, the configuration and method of the embodiments described as above cannot be limitatively adopted, but the embodiments may be configured by selectively combining all the embodiments or some of the embodiments so that various modifications can be made.

What is claimed is:

1. A method for providing a local service using an RFID tag of a portable terminal, comprising:
when the corresponding portable terminal reaches a predetermined region, transmitting RFID tag information including information of a mobile communication server in which the corresponding portable terminal is registered to a local server of a corresponding region;
receiving a mode switching request message from the mobile communication server in which the corresponding portable terminal is registered at the request of the local server that receives the RFID tag information of the corresponding portable terminal through a mobile communication network;
inquiring whether or not a mode is switched of the corresponding user from the mode switching request message in the receiving step; and
switching an operation mode of the portable terminal by the mode switching request message when a mode switching request of the corresponding portable terminal is accepted from the inquiry result of the inquiring step.

2. The method for providing a local service using an RFID tag of a portable terminal according to claim 1, wherein the mode switching request message includes inquiry data to inquire whether or not the mode of the corresponding portable terminal is switched and a control command to switch the operation mode of the corresponding portable terminal with respect to a response of the portable terminal to the inquiry data.

3. The method for providing a local service using an RFID tag of a portable terminal according to claim 1, wherein the RFID tag information further includes at least one of an ID of the RFID tag and a user's own ID registered in the corresponding mobile communication server.

4. The method for providing a local service using an RFID tag of a portable terminal according to claim 1, wherein in the switching, the operation mode of the portable terminal is switched to a vibration mode or a silent mode.

5. The method for providing a local service using an RFID tag of a portable terminal according to claim 1, wherein in the switching, a power supply of the corresponding portable terminal is turned off.

6. A method for providing a local service using an RFID tag of a portable terminal, comprising:
when the corresponding portable terminal reaches a predetermined region, transmitting RFID tag information including information of a mobile communication server in which the corresponding portable terminal is registered to a local server of a corresponding region;
receiving a service use inquiry message from the mobile communication server in which the corresponding portable terminal is registered at the request of the local server that receives the RFID tag information of the corresponding portable terminal through a mobile communication network;
inquiring whether or not a service is used of the corresponding user from the service use inquiry message in the receiving step and requesting the service of the corresponding local server by using a service number corresponding to the RFID tag when the usage of the corresponding service is accepted; and
receiving the local service from the corresponding local server on the basis of the service number corresponding to the RFID tag.

7. The method for providing a local service using an RFID tag of a portable terminal according to claim 6, wherein the service use inquiry message includes at least one of inquiry data to inquire whether or not the corresponding local service is used, local service guide information which is usable in the corresponding portable terminal, and information on the local server which provides the corresponding service.

8. The method for providing a local service using an RFID tag of a portable terminal according to claim 6, wherein the service use inquiry message further includes the service number corresponding to the RFID tag.

9. The method for providing a local service using an RFID tag of a portable terminal according to claim 6, wherein the service number corresponding to the RFID tag is an instance number which is generated by the local server in correspondence with the RFID tag of the portable terminal.

10. The method for providing a local service using an RFID tag of a portable terminal according to claim 6, wherein the local service is a program download service for providing at least one of content in the corresponding region.

11. A portable terminal with an RFID tag, comprising:
an RFID tag that, when the corresponding portable terminal reaches a predetermined region, transmits RFID tag information including information of a mobile communication server in which the corresponding portable terminal is registered to a local server of a corresponding region; and
a data processing unit that executes the corresponding local service when the user accepts usage of the local service in accordance with a user's control command at the time of receiving an inquiry message to verify whether or not a user uses the local service from the mobile communication server at the request of the local server that receives the RFID tag information,
wherein the inquiry message includes at least one of a mode switching request message or a service use inquiry message.

12. The portable terminal with an RFID tag according to claim 11, wherein the mode switching request message includes inquiry data to inquire whether or not a mode of the corresponding portable terminal is switched and a control command to switch an operation mode of the corresponding portable terminal in correspondence with a response of the portable terminal to the inquiry data.

13. The portable terminal with an RFID tag according to claim 11, wherein the RFID tag information further includes at least one of an ID of the RFID tag and a user's own ID registered in the corresponding mobile communication server.

14. The portable terminal with an RFID tag according to claim 11, wherein in the case in which the inquiry message is the mode switching request message, the data processing unit switches the operation mode of the corresponding portable terminal by the mode switching request message when the user accepts switching the operation mode.

15. The portable terminal with an RFID tag according to claim 14, wherein the data processing unit switches the operation mode of the corresponding portable terminal to a vibration mode or a silent mode when the operation mode of the portable terminal is switched.

16. The portable terminal with an RFID tag according to claim 14, wherein the data processing unit turns off a power supply of the corresponding portable terminal when the operation mode of the portable terminal is switched.

17. The portable terminal with an RFID tag according to claim 11, wherein the service use inquiry message includes at least one of inquiry data to inquire whether or not the corresponding local service is used, guide information of the local service which is usable in the corresponding portable terminal, and information on the local server which provides the corresponding service.

18. The portable terminal with an RFID tag according to claim 11, wherein the service use inquiry message further includes a service number corresponding to the RFID tag.

19. The portable terminal with an RFID tag according to claim 18, wherein the service number corresponding to the RFID tag is an instance number which is generated by the local server in correspondence with the RFID tag of the portable terminal.

20. The portable terminal with an RFID tag according to claim 18, wherein the data processing unit receives the service from the corresponding local server on the basis of the service number corresponding to the RFID tag when the corresponding local service is used from the service use inquiry message.
